(19) United States
(12) Patent Application Publication
(10) Pub. No.: US 2010/0288234 A1
(43) Pub. Date: Nov. 18, 2010

(54) SYSTEM FOR SEALED CONNECTION BETWEEN TUBULAR SECTIONS, IN PARTICULAR FOR THE SEALED CONNECTION OF A PIPE FOR FEEDING COMBUSTIBLE GAS AT HIGH PRESSURE WITH A PRESSURE REDUCER IN AUTOMOTIVE INTERNAL COMBUSTION MACHINES

(76) Inventors: Maurizio Grando, Ghirignano (IT); Guido Gritti, Padova (IT); Salvatore Celesti, Ramon di Loria (IT)

Correspondence Address: CASTELLANO PLLC, P.O. Box 1555, Great Falls, VA, 22066, US

(21) Appl. No.: 12/811,407

(22) PCT Filed: Dec. 23, 2008
(86) PCT No.: PCT/IT2008/000788

§ 371 Date: Jul. 1, 2010

(30) Foreign Application Priority Data
Jan. 10, 2008 (IT) PD2008A000009

(51) Int. Cl. F02M 69/54; F16L 37/14

(52) U.S. Cl. 123/457; 285/80

(57) ABSTRACT

A system is described for sealed connection between a pair of tubular sections (3, 2a) intended to convey a gaseous fluid under pressure, wherein the sections are capable of relative orientation from and towards a preselected positioning at which they are rigidly connected to each other with a sealed connection. The system comprises nesting coupling means, respectively provided on one and the other of the tubular sections coaxially engageable with each other, gastight sealing means between the tubular sections, axial checking means (6, 7) between the nesting coupling means for holding one of the tubular sections relative to the other section in the direction of mutual axial coupling (X). The system also comprises removable locking means (10) between the sections (3, 2a) for rigidly locking the tubular sections to each other in the state of preselected relative positioning, wherein the locking means (10) for the relative orientation between the sections are independent of the axial checking means (6, 7), such that the gastight seal is ensured in the state in which the tubular sections are freely orientable with respect to each other without any action of the locking means.

### TECHNICAL FIELD

The present invention concerns a system for sealed connection between tubular sections having the characteristics mentioned in the preamble of the main claim No. 1.

### TECHNOLOGICAL BACKGROUND

The present invention lends itself particularly, although not exclusively, to application in gastight connection systems of pipes for feeding combustible gas in feed systems of automotive internal combustion engines. In such applications there is a need to connect in a sealed manner the feed pipe for the combustible gas, fed from a suitable tank, to the pressure reducer of the feed system, the pipe then being subjected, in operation, to high pressure. By reason of the plant engineering which distinguishes such feed systems, the aforesaid pipe typically needs to have a relative orientation with respect to the connecting means of the reducer such as to make it possible, at the site of connection, to obtain a preselected relative positioning with respect to the reducer, and once that positioning has been achieved to ensure relative locking with a gastight seal. In general, the feed pipe has at the end a connecting means or union elbow which provides relative angulation between the tubular portion for nesting in the reducer and the pipe.

The currently known solutions provide for a system for connection between the end sections of the gas feed pipe and for entry into the reducer, wherein the sealing means act between the parts in question only when the tubular sections are rigidly locked to each other in the preselected relative angular positioning. Generally, a screw-type locking means is provided for clamping a gasket, for example a sealing ring, and at the same time for securing the tubular sections rigidly to each other as a result of the clamping thereof.

A limitation encountered with such a solution is that the gastight seal cannot be obtained in the state in which the tubular sections are freely orientable with respect to each other, i.e. in the state in which there is no involvement of the screw-type locking means.

In this regard, since the gastight seal, between the gas feed connector and the inlet of the reducer, can be obtained only at the site of installation of the equipment, the testing of the seal has to take place in that phase, without it therefore being able to be carried out and ensured at the site of production of the individual components, independently of the following installation phase, such a prerogative proving difficult to accept, and contrasting in particular with the safety and testing standards required for high pressure pipes in the technical field of automotive gas equipment.

Moreover, the aforesaid known solution, although on the one hand it ensures mutual locking of the coupled sections, on the other hand it does not prove to be particularly rapid and flexible, not permitting free orientation with simultaneous gastight sealing in the mutual positioning of the coupled tubular sections.

### DESCRIPTION OF THE INVENTION

The problem underlying the present invention is that of providing a sealed connection system structurally and functionally designed so as to remedy the limitations mentioned with reference to the prior art cited.

This problem is solved by the invention by means of a sealed connection system produced according to the following claims.

### BRIEF DESCRIPTION OF THE DRAWINGS

Further characteristics and advantages of the invention will become clearer from the following detailed description of a preferred exemplary embodiment thereof, illustrated by way of non-limiting example with reference to the appended drawings, in which:

FIG. 1 is a schematic view of a connection system according to the invention, between a pressure reducer and a pipe for feeding gas to the reducer itself,

FIGS. 2 and 3 are partial views from the top and from the side, of a detail of the connection system of FIG. 1,

FIG. 4 is a view in section along the line IV-IV of FIG. 2,

FIGS. 5 and 6 are views in section respectively along the lines V-V and VI-VI of FIG. 3,

FIG. 7 is a partial perspective view of the connection system of the preceding Figures.

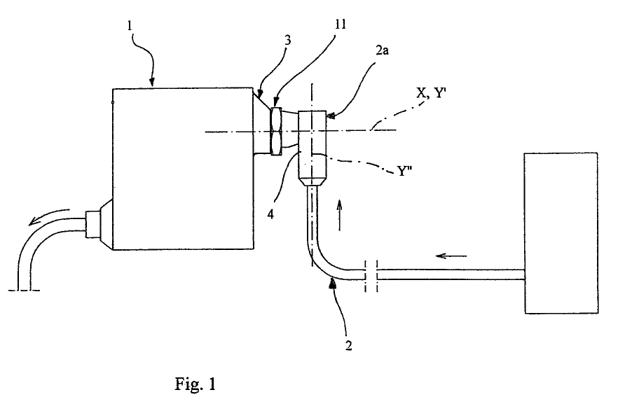

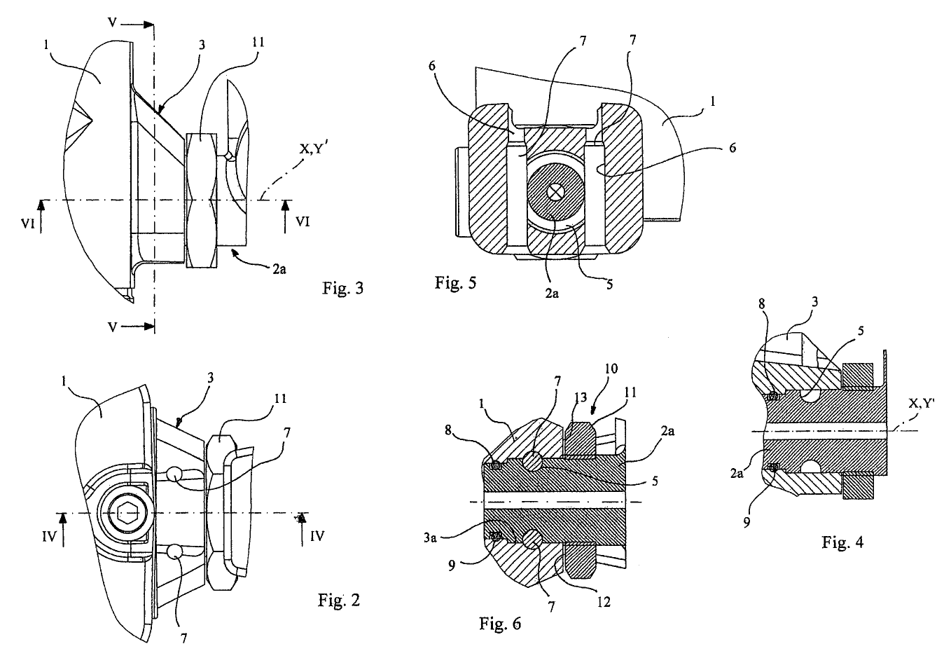

### PREFERRED EMBODIMENTS OF THE INVENTION

With reference to the drawings mentioned, the reference 1 indicates a pressure reducing device, shown only schematically, arranged to be connected to a pipe 2 for feeding a combustible gas, at high pressure, also shown only partially, according to a sealed connection system produced according to the present invention.

The invention finds a particular, although not exclusive, application in the connection of the inlet sections of reducers with high pressure pipes intended for feed systems for combustible gases in internal combustion engines, such as, for example, LPG or methane. It is to be understood that such an application represents a preferred choice, the connection system according to the invention equally being applicable, in more general terms, to any condition in which a sealed connection is required between two tubular sections of a pipe for conveying a fluid under pressure.

The connection system provides for a tubular section 3 protruding from the body of the reducer, and defining the inlet section for the high pressure gas conveyed by the pipe 2. In the section 3 a tubular portion is formed, comprising a seat with a cylindrical axial bore 3a, capable of being engaged, in an axial nesting coupling, by a corresponding tubular end section 2a of the pipe 2. The seat 3a extends axially in a direction indicated by X in the drawings.

The tubular section 2a extends in a first portion 4a of a attachment member (connector) 4, which is extended in a second tubular portion 4b of the member, the first and the second portion being angled with respect to each other. Y′ and Y″ respectively indicate the axial directions, incident with each other, in which the first and the second portions 4a, 4b extend. A preferred angulation between the directions Y′ and Y″ is 90°.

In more detail, the pipe 2 is connected at one of its ends to the inlet of the connecting portion 4b, such that the outlet section of the connector (defined in the other portion 4a), capable of sealed connection with the reducer, is angled with respect to the inlet section, this configuration being typically preferred, in plant engineering applications of the aforesaid type. As a consequence, following the coupling with axial nesting between the sections 2a, 3 (with axes X and Y′ coaxial) the connector 4 is freely orientable about the axis X, until a preselected relative positioning between the pipe 2 and the reducer 1 is obtained.

Returning to the section 2a, this has a tubular portion having in its outer cylindrical wall a transverse groove 5, extending circumferentially, which is capable of co-operating with a pair of respective slots 6 provided in the axial bore of the seat 3a, by means of the intervention of axial checking means, suitable for axially locking the section 2a with respect to the section 3, as result of the mutual axial nesting.

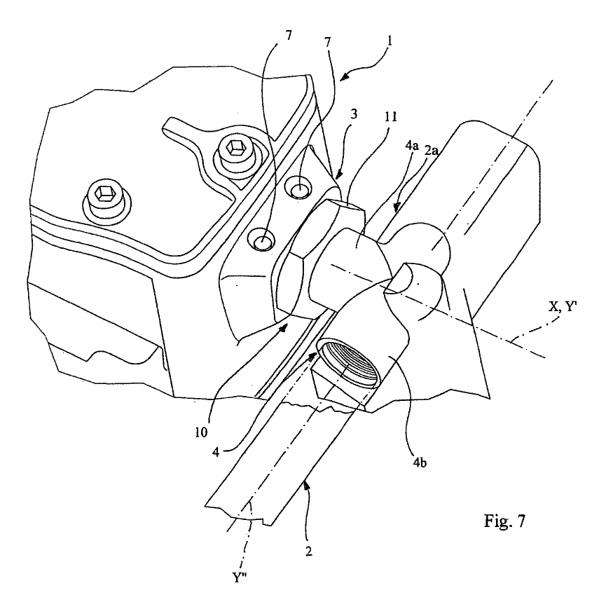

Said axial checking means comprise a pair of cylindrical pin-type members, both indicated by 7, which are arranged to be set into the section 3, on diametrically opposed sides, such that each pin 7 engages, in part, the corresponding slot 6, remaining held in the section 3, and protrudes inside the seat 3a, engaging part of the corresponding facing groove 5 provided in the section 2. Owing to the mutual arrangement of the cylindrical pins 7, parallel to each other and arranged on diametrically opposed sides (at the generating lines of the cylindrical seat 3a), as a result of the engagement of the pins in the corresponding slots and in the groove, the tubular sections 2a and 3 remain mutually held with respect to each other in the axial direction X, with the possibility of free relative rotation between the sections about the axial direction X of nesting. This configuration is clearly illustrated in FIG. 6.

In such a condition the gastight seal between the coupled sections is also ensured by means of a sealing ring 8, for example of the O-ring type, interposed between the coupling cylindrical surfaces of the tubular sections 2a, 3. For example, a circumferential recess 9 may be provided on the outer wall of the section 2a, suitable for forming a seat for housing the sealing ring 8, which is brought into relative sliding contact with the cylindrical wall, facing it, of the section 3, once the axial coupling phase is completed. It should be noted that the sealing system is designed to ensure a seal between surfaces in relative rotation, and the sections 2a and 3 may have free relative orientation about the axis X.

For relative locking between the tubular sections 2a, 3, in the preselected positioning, the system comprises locking means, indicated as a whole by 10, which are structurally and functionally independent of the axial checking means described above.

Said locking means comprise a ring nut or screw nut 11, screwed onto an externally threaded part of the connector portion 4a. The ring nut has at one of its ends a lateral surface 12 capable of abutting against a corresponding surface shoulder 13 provided at the end of the tubular portion of the section 3. As shown in FIG. 6, the screwing of the ring nut 11 onto the section 2a brings the surfaces 12 and 13 into mutual abutment, placing the section 2a under tension with respect to the portion 3, so as to ensure, owing to the tensions induced by the screwing of the ring nut, relative locking between the connector 4 (and therefore the pipe 2) and the reducer 1, in the preselected relative positioning previously reached.

The invention thus solves the problem posed, providing numerous advantageous compared with the known solutions.

The principal advantage lies in the fact that, owing to the connection system of the invention, the gastight seal between the connector and the reducer is ensured even in the state of free relative orientability between them. This entails the advantage of being able to ensure and test the seal between the coupled sections already at the site of production, irrespective of the installation conditions, but at the same time facilitating installation owing to the free relative orientability of the sections.

There should further be added thereto the rapidity and ease of sealed coupling (and uncoupling) between the reducer and the pipe, which can be of particular value in the phase of assembly (disassembly) on site by the installer.

A further advantage lies in the relative orientability between the reducer and the feed pipe (while ensuring mutual gastight axial retention), which facilitates the installation of the equipment by increasing the flexibility of layout thereof.

1. A system for sealed connection between a pair of tubular sections intended to convey a gaseous fluid under pressure, wherein the sections are capable of relative orientation from and towards a preselected positioning at which they are rigidly connected to each other with a sealed connection, the system comprising:
nesting coupling means, respectively provided on one and the other of said tubular sections coaxially engageable with each other,
gastight sealing means between said tubular sections,
axial checking means between said nesting coupling means for retaining one of the tubular sections relative to the other section in the direction of mutual axial coupling, wherein they comprise removable locking means between the sections for rigidly locking said tubular sections to each other in the state of the preselected relative positioning, and in that said means for locking the relative orientation between the sections are independent of said axial checking means, such that the gastight seal is ensured in the state in which the tubular sections are freely orientable with respect to each other without any action of the locking means.

2. A sealed connection system according to claim 1, wherein said coupling means comprise a tubular portion in one of said sections having a transverse groove in its outer wall, the portion being capable of being received in a seat defined in the other section, said checking means comprising at least one checking member held axially with respect to the seat and extending for at least some distance into said seat in an arrangement such as to engage the groove when the tubular portion is received in the seat so as to lock the tubular sections axially to each other, with a possibility of free relative rotation between the sections about the axial nesting direction.

3. A system according to claim 2, wherein said at least one axial checking member is removably engageable in said seat.

4. A system according to claim 2, wherein two checking members in the shape of a cylindrical pin are provided, capable of engaging said seat transversely to the axial nesting direction and on diametrically opposed sides of the groove, so as to hold one tubular section axially in the other but to permit the free relative rotation thereof about the axial nesting direction.

5. A system according to claim 1, wherein said locking means comprise a ring nut or locking nut, screwed onto one of the sections and capable of abutting against the other section as a result of the screwing operation, so as to secure said sections rigidly to each other.

6. A system according to claim 1, wherein one of said tubular sections is an inlet section of a pressure reducer and the other section is part of an end connector of a pipe for feeding gas to the reducer, wherein said connector comprises tubular portions angled with respect to each other.

7. A system according to claim 6, wherein said pressure reducer is intended to be fed with gas at high pressure in a system for feeding combustible gas to automotive internal combustion engines.

8. A system according to claim 1, wherein said sealing means comprise a sealing ring, of an O-ring type, housed in a recess provided on one of said sections and capable of sliding surface contact on the other section, by the effect of the free relative orientability between said sections.
